(19) United States
(12) Patent Application Publication
(10) Pub. No.: US 2024/0210285 A1
(43) Pub. Date: Jun. 27, 2024

(54) FLUID MONITORING DEVICE AND METHODS OF USE THEREOF

(71) Applicant: Virolock Technologies Limited Liability Company, State College, PA (US)

(72) Inventors: Nestor Perea-Lopez, State College, PA (US); Mauricio Terrones, State College, PA (US)

(21) Appl. No.: 18/392,506

(22) Filed: Dec. 21, 2023

Related U.S. Application Data
(60) Provisional application No. 63/476,785, filed on Dec. 22, 2022.

(51) Int. Cl. G01N 1/24; G01N 1/22

(52) U.S. Cl. CPC G01N 1/24; G01N 2001/2285

(57) ABSTRACT

Embodiments relate to a fluid monitoring device that may be used to capture viruses or other suitable sized particles. The fluid monitoring device can comprise a base, cover, Tesla valve, and means for pumping a fluid. The base can have a channel wherein the channel has two end points. The cover can have an inlet and an outlet. The cover can be mounted on the base wherein the inlet is adjacent to the first end point and the outlet is adjacent to the second end point. The Tesla valve can be positioned within the channel. The Tesla valve can have a forward flow direction and a reverse flow direction. The means for pumping a fluid is for directing a fluid from the inlet to the outlet and can be configured to the cover.

### CROSS-REFERENCE TO RELATED APPLICATIONS

This patent application is related to and claims the benefit of priority to U.S. provisional patent application No. 63/476,785, filed on Dec. 22, 2022, the entire contents of which is incorporated herein by reference.

### FIELD OF THE INVENTION

Embodiments relate to a fluid monitoring device and methods of use thereof. More particularly, embodiments relate to a fluid monitoring device that may be used to capture viruses or other suitable sized particles and methods of use thereof.

### BACKGROUND OF THE INVENTION

The ability of viruses to rapidly and unpredictably mutate can result in epidemics and pandemics. Virus surveillance, particularly the detection of viral particles in fluids, is an essential step in mitigating the next outbreak. Virus detection in fluids, particularly aerosols, has been attempted in the past under a variety of experimental conditions ranging from the laboratory, hospital wards, mass transportation, and airplanes; however, large-scale detection is complicated. Current pathogen identification technologies (e.g., fluid monitoring devices) are limited by poor viral capture efficiency, lack of portability, cost, and slow downstream analysis methods. Accordingly, there is a clear need for a faster, simpler, and cheaper fluid monitoring device that can be widely accessible to the public for use in communal spaces such as offices, mass transport, restaurants, or even at home.

### SUMMARY OF THE INVENTION

Embodiments relate to a fluid monitoring device that may be used to capture viruses or other suitable sized particles. The fluid monitoring device can comprise a base, cover, Tesla valve, and means for pumping a fluid. The base can have a channel wherein the channel has two end points. The cover can have an inlet and an outlet. The cover can be mounted on the base wherein the inlet is adjacent to the first end point and the outlet is adjacent to the second end point. The Tesla valve can be positioned within the channel. The Tesla valve can have a forward flow direction and a reverse flow direction. The means for pumping a fluid is for directing a fluid from the inlet to the outlet and can be configured to the cover.

In some embodiments, at least a portion of the fluid monitoring device can be optically transparent whereby at least a portion of the Tesla valve is visible within the fluid monitoring device.

In some embodiments, the fluid can be air containing droplets and aerosols.

In some embodiments, the Tesla valve can be positioned within the channel such that the reverse flow direction is oriented from the inlet to the outlet.

In some embodiments, the Tesla valve can be positioned within the channel such that the forward flow direction is oriented from the inlet to the outlet.

In some embodiments, the Tesla valve can be positioned within the channel to allow at least a portion of the fluid to flow through and around the Tesla valve.

In some embodiments, at least a portion of the Tesla valve can be porous.

In some embodiments, the length of the Tesla valve can be at least a portion of the length of the channel.

In some embodiments, the fluid monitoring device can further comprise a second Tesla valve positioned within the channel.

In some embodiments, the channel can have a path shape, wherein the path shape can be straight, zig-zag, or serpentine.

In some embodiments, the means for pumping a fluid can be a vacuum pump, the vacuum pump being configured to the outlet of the cover.

In some embodiments, the device can be contained in a portable housing.

An exemplary embodiment relates to a method of capturing particles from a fluid sample using a fluid monitoring device. An embodiment of a fluid monitoring device can comprise a base, cover, Tesla valve, and means for pumping a fluid. The base can have a channel wherein the channel has two end points. The cover can have an inlet and an outlet. The cover can be mounted on the base wherein the inlet is adjacent to the first end point and the outlet is adjacent to the second end point. The Tesla valve can be positioned within the channel. The Tesla valve can have a forward flow direction and a reverse flow direction. The means for pumping a fluid is for directing a fluid from the inlet to the outlet and can be configured to the cover. The method can involve actuating the means for pumping a fluid. The method can involve allowing a fluid to enter the inlet of the device and pass through the channel, the fluid containing particles. The method can involve capturing the particles within the Tesla valve. The method can involve allowing the fluid to exit the outlet of the device.

In some embodiments of the method, the fluid can be air containing droplets and aerosols carrying the particles.

In some embodiments of the method, the particles can be selected from the group consisting of bacteria, virus, fungal spores, pollen, microalgae, plasmodium, and amoebas.

In some embodiments of the method, means for pumping a fluid can be a vacuum pump, the vacuum pump being configured to the outlet of the cover and actuating the vacuum pump pulls the fluid into the inlet of the device, through the channel and the Tesla valve, and out the outlet of the device.

In some embodiments, the method can further comprise analyzing the captured particles.

In some embodiments of the method, analyzing the captured particles can comprise a technique selected from the group consisting of Raman spectroscopy, fluorescence spectroscopy, and plasmonics.

In some embodiments, the method can further comprise releasing the captured particles and analyzing the captured particles.

In some embodiments of the method, releasing the captured particles can comprises mechanical abrasion of the Tesla valve and analyzing the particles can comprise a technique selected from the group consisting of ELISA, PCR, NGS, and culture.

In some embodiments, the method can involve recirculating the fluid before to exiting the outlet of the device to increase a number of particles captures within the Tesla valve or a likelihood of capturing the particles within the Tesla valve.

### BRIEF DESCRIPTION OF THE DRAWINGS

The above and other objects, aspects, features, advantages, and possible applications of the present innovation will be more apparent from the following more particular description thereof, presented in conjunction with the following drawings. Like reference numbers used in the drawings may identify like components.

FIG. 1 is an exploded, perspective view of an embodiment of a fluid monitoring device.

FIG. 2 is a perspective view of an embodiment of a fluid monitoring device.

FIG. 3 is a cross sectional view of an embodiment of a fluid monitoring device. The axis 3× of the cross-sectional view is depicted in FIG. 1.

FIG. 4 is a cross sectional view of an embodiment of a fluid monitoring device. The axis 3× of the cross-sectional view is depicted in FIG. 1.

FIG. 5 is a cross sectional view of an embodiment of a fluid monitoring device. The axis 3× of the cross-sectional view is depicted in FIG. 1.

FIG. 6 is a scanning electron microscope (SEM) micrograph of a carbon nanotube array fin tip of a Tesla valve showing fluorescent nanoparticles captured from a liquid sample.

FIG. 7A is a perspective view of an embodiment of a housing.

FIG. 7B is a perspective view of an embodiment of a housing placed in a user's hand.

FIG. 8A is a perspective view of an embodiment of a housing and an embodiment of a fluid monitoring device.

FIG. 8B is a bottom perspective view of an embodiment of a fluid monitoring device configured to an embodiment of a housing. A zoomed-in profile of an embodiment of a Tesla valve is shown on the right.

FIG. 9A is a perspective view of an embodiment of a housing and an embodiment of an optical analyzer.

FIG. 9B is a perspective view of an embodiment of a housing and an embodiment of a sample extraction unit.

FIG. 10—Airborne particle generator using a nebulizer to generate fine particles (<1 μm) connected in series with a sprayer that generates larger droplets (>1 μm), the combined particle emission simulates a realistic cough or human sneeze showing a bimodal particle size distribution.

FIG. 11—Schematic showing the virus isolation chamber, the bioaerosol generator, and the air samplers.

FIG. 12A—Infectious Bronchitis Virus (IBV) infected chicken inside an isolation room.

FIG. 12B—Bioaerosol monitors placed near the air exhaust of the isolation room (BSL-2 facility).

FIG. 13A—The National Institute for Occupational Safety and Health Bioaerosol Cyclone 251 (NIOSH BC-251) sampler.

FIG. 13B—View of inserted carbon nanotube arrays in the stage 2 vial of the NIOSH BC-251 air sampler.

FIG. 13C—View of inserted carbon nanotube arrays in the stage 2 vial of the NIOSH BC-251 air sampler.

FIG. 13D—An embodiment of a microfluidic carbon nanotube Tesla valve.

FIG. 14A—15 ml vial form stage 1 of the NIOSH BC-251 air samples showing shed dust from the chickens.

FIG. 14B—2 ml vial from stage 2 of the NIOSH BC-251 air sampler, the red arrow points at a diagonal trace of fine powder collected from the chickens.

FIG. 14C—Stage 2 vial containing inserted carbon nanotube arrays used to evaluate the capture ability of the CNTs.

FIG. 15—The CNT array on a petri dish showing the suspended CNTs scratched using a sterile needle, this suspension was pipetted and diluted in 250 μL universal transport media (UTM) and vortexed before PCR.

FIG. 16A—Carbon nanotube array in Herringbone arrangement.

FIG. 16B—Carbon nanotube array in Tesla valve arrangement.

FIG. 16C—Tesla valve geometry where the air can follow two parallel channels.

FIG. 17A—Fluorescence microscopy images of nanoparticles captured by the carbon nanotube Tesla Valve. FIGS. 17A and 17B are the same area and the carbon nanotubes are of comparable length around 60 μm.

FIG. 17B—Fluorescence microscopy images of nanoparticles captured by the Herringbone carbon nanotube array. FIGS. 17A and 17B are the same area and the carbon nanotubes are of comparable length around 60 μm.

FIG. 18A—Photograph of a carbon nanotube Tesla valve after IBV spiked aerosol capture, white flow lines and noticeable particles get trapped in the Tesla Valve region (inset).

FIG. 18B—After removing the polydimethylsiloxane (PDMS) cap the device got a few nanometer gold coating to prevent charge accumulation during electron irradiation in the SEM microscope, the evidence of aerosol captured virus material is highlighted in red.

FIG. 19—Semilog plot of the PCR Ct threshold cycle of detection versus the sampled air volume. The red stars represent experiments with live virus shed by chickens in an isolation room while the blue stars are from controlled experiments with nebulized inactivated IBV virus in a static air chamber. PCR results can classified in three regions Ct below 35 represents a positive PCR detection (green), positive suspicious between 35 and 40 (gray) and No detection (red) for Ct larger than 40. The plot also indicates the ideal corner with low Ct and small sampled air volume.

FIG. 20—SEM micrograph of a CNT array fin tip of a Tesla valve showing fluorescent nanoparticles captured from an aerosol sample.

FIG. 21 is a unit cell of a Tesla valve. Win is the width of the Tesla valve channel at the entrance; Wout is the width of the Tesla valve channel at the output; Lₐ, L_{b}, and L_{c} define the shape of the tesla valve; and a is the angle of the fin (0 and 90°).

FIG. 22 shows the forward and reverse direction of flow in a unit cell of a Tesla valve. H_{W} is the height of the walls, and H_{F} is the height of the fin. In some embodiments, H_{W} is the same or approximately the same as H_{F}.

FIG. 23 shows SEM micrographs of CNT tesla valve used to enrich SARS-COV-2 in from a 1:1×10⁶ dilution. In frame (c) It is possible to notice corpuscles that resemble trapped virus material. PCR analysis of this material confirms the capture of SARS-COV-2 in the nanotube arrays, while the SEM shows the preferential sites where the virus is retained at the tips of the tesla valve fins, in an analogous way as that observed in the air monitoring experiments.

### DETAILED DESCRIPTION OF THE INVENTION

The following description is of exemplary embodiments that are presently contemplated for carrying out the present invention. This description is not to be taken in a limiting sense but is made merely for the purpose of describing the general principles and features of various aspects of the present invention. The scope of the present invention is not limited by this description.

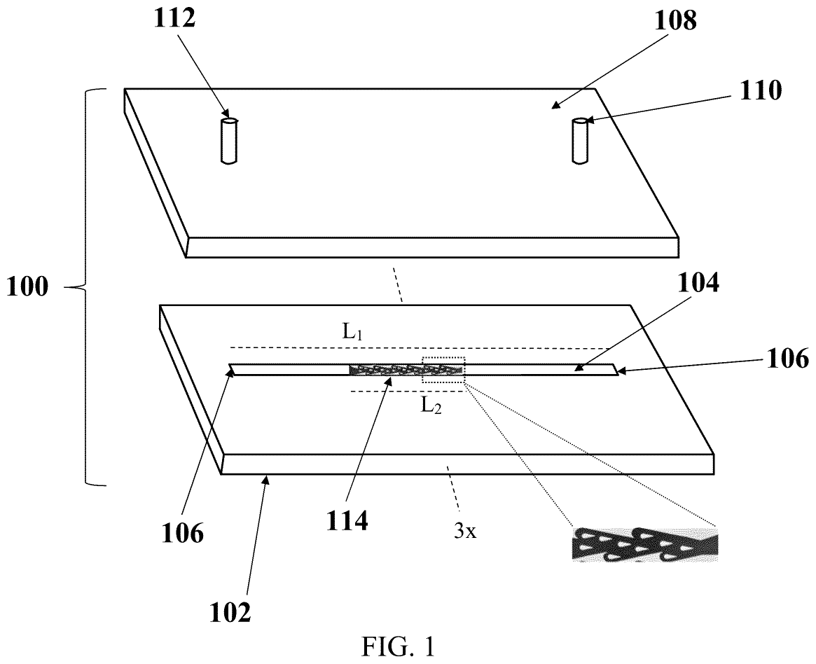

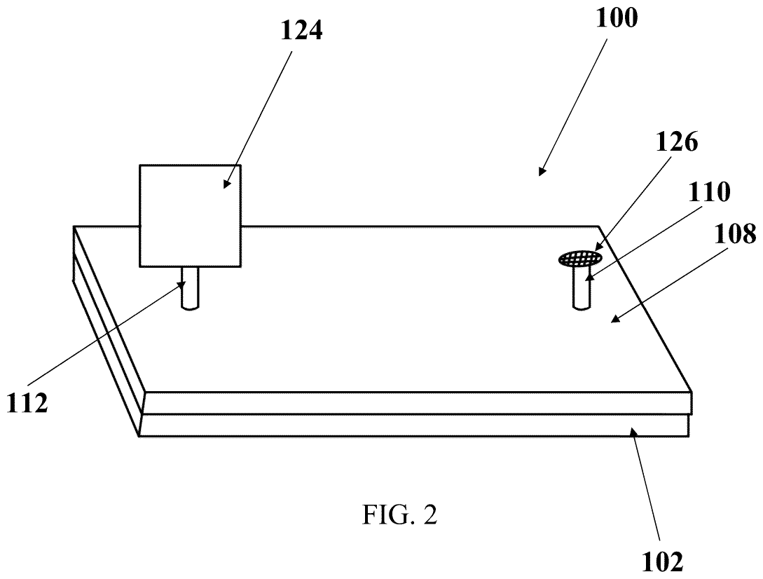

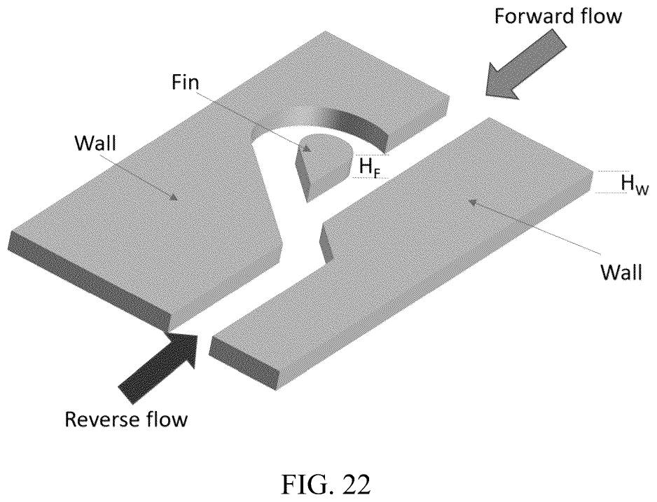

As shown in FIG. 1, the fluid monitoring device 100 can comprise a base 102, cover 108, Tesla valve 114, and means for pumping a fluid 124. A base 102 can have a channel 104 wherein the channel 104 can have two end points 106. A cover 108 can have an inlet 110 and outlet 112. A cover 108 can be mounted on a base 102. A first end point 106 of a channel 104 can be adjacent to an inlet 110, and a second end point 106 can be adjacent to an outlet 112. It is contemplated that an assembled fluid monitoring device 100 creates a closed channel 104 with two openings at an inlet 110 and outlet 112. As shown in FIG. 2, when a cover 108 is mounted on a base 102, the edges of the cover 108 and base 102 can be contiguous such that the assembled fluid monitoring device 100 forms a uniform shape. An assembled fluid monitoring device 100 can be any shape (e.g., circular, triangular, rectangular, etc.). In some embodiments, a cover 108 can be removable. A base 102 and cover 108 of a fluid monitoring device 100 can be made of any suitable material (e.g., plastics, metals, glass, polymers, polydimethylsiloxane (PDMS), quartz etc.). In some embodiments, at least a portion of the base 102 and/or cover 108 is optically transparent such that at least a portion of a Tesla valve 114 within a device 100 is visible for optical analysis. A Tesla valve 114 can be positioned within a channel 104. As shown in FIG. 22, a Tesla valve 114 can have a forward flow direction and a reverse flow direction. The means for pumping a fluid 124 can be for directing a fluid from the inlet 110 to the outlet 112 and can be configured to the cover 108. A fluid monitoring device 100 can be a cartridge and/or microfluidic device. A fluid monitoring device 100 can also be sterile.

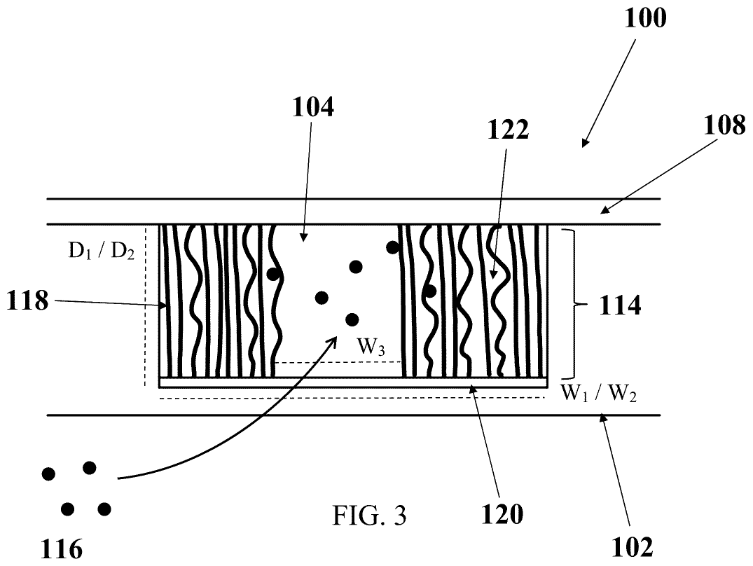

A fluid monitoring device 100 can have any number of channels 104. In some embodiments, there are a plurality of channels 104 with one end point 106 of each channel 104 merging at the inlet 110 and the other end point 106 of each channel 104 merging at the outlet 112. Alternatively, one end point 106 of each channel 104 can merge into a singular channel 104 where the end point 106 of the single channel 104 aligns with an inlet 110 or outlet 112. A channel 104 might be branched at one end or both. It is contemplated that, in such embodiments, a cover 108 can have a plurality of inlets 110 and/or outlets 112 which align with the various end points 106 of the channel 104. For example, a channel 104 might be Y-shaped where the cover 108 has two inlets 110 and a single outlet 112. The two inlets 110 can be aligned with the branched end points 106 (e.g., at the top of the “Y”) and the outlet 112 can be aligned with the remaining end point 106. As shown in FIG. 1, the path of a channel 104 can have any shape (e.g., straight, zig-zag, or serpentine, etc.). As shown in FIGS. 1 and 3, channel 104 can have any length L₁, depth D₁, and width W₁. The length L₁, depth D₁, and width W₁ can be on the order of micrometers to meters. In some embodiments, the depth D₁ and/or width W₁ of a channel 104 can be about constant. Alternatively, the depth D₁ and/or width W₁ of a channel 104 can vary. As shown in FIG. 3, the cross-sectional shape of a channel 104 can be rectangular. In some embodiments, a channel 104 can have any cross-sectional shape (e.g., square, circular, triangular etc.).

A fluid monitoring device 100 can have any suitable means for pumping a fluid 124 from the inlet 110 to the outlet 112 (e.g., vacuum, syringe, squeeze bulb, etc.). A means 124 can be configured to the inlet 110 or outlet 112 of the cover 108. As shown in FIG. 2, a fluid monitoring device 100 can be configured to a vacuum pump 124. A vacuum pump 124 can be connected to an outlet 112 of the cover 108 such that the vacuum pump 124 pulls fluid into the device 100, through a channel 104 and a Tesla valve 114, and out the outlet 112. In some embodiments, a vacuum pump 124 can be connected to an outlet 110 of a housing 128 and achieve the same effect. The vacuum pump 124 can be battery-operated or powered by an AC/DC adaptor. The vacuum pump 124 can be similar to those found in the art.

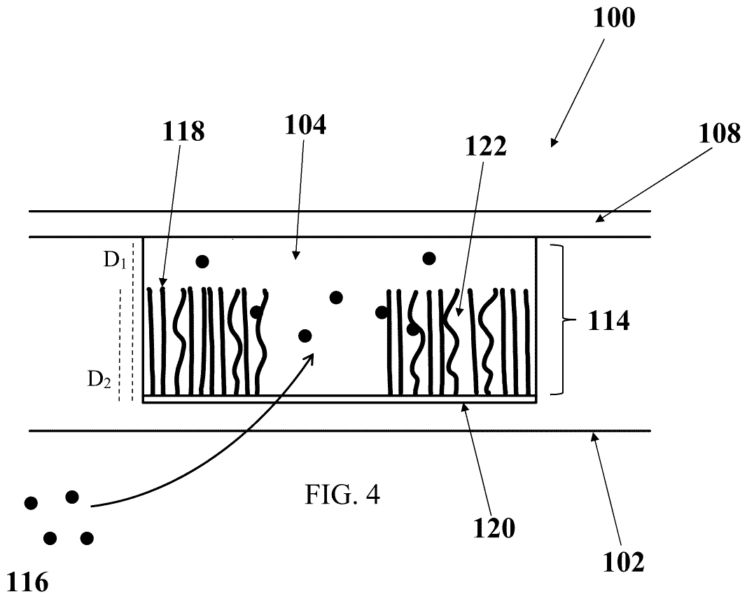

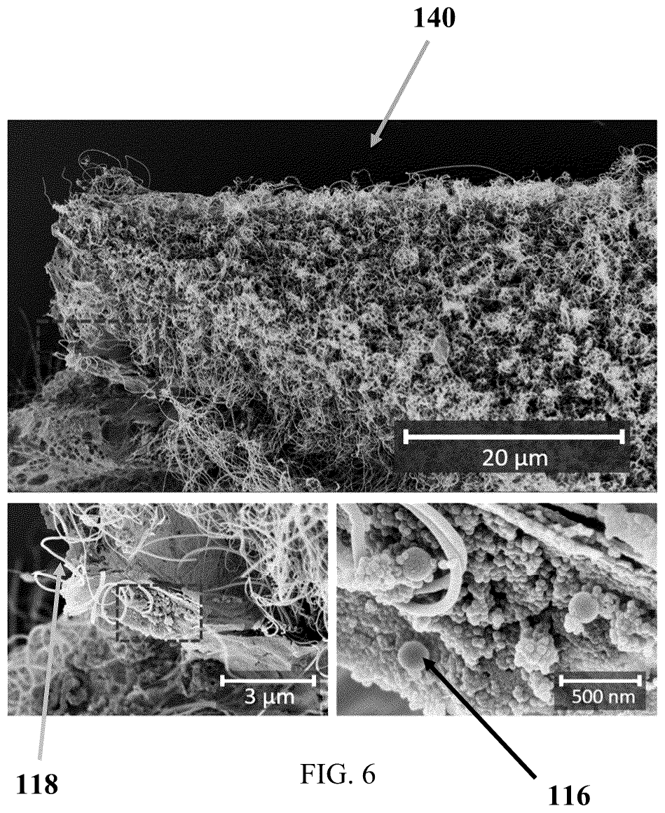

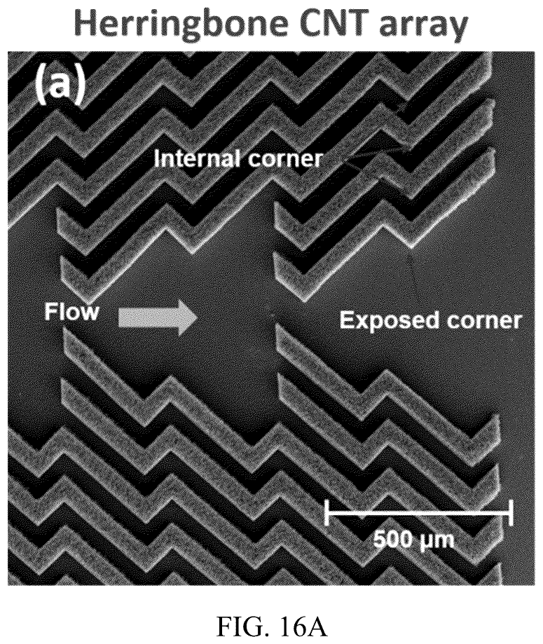

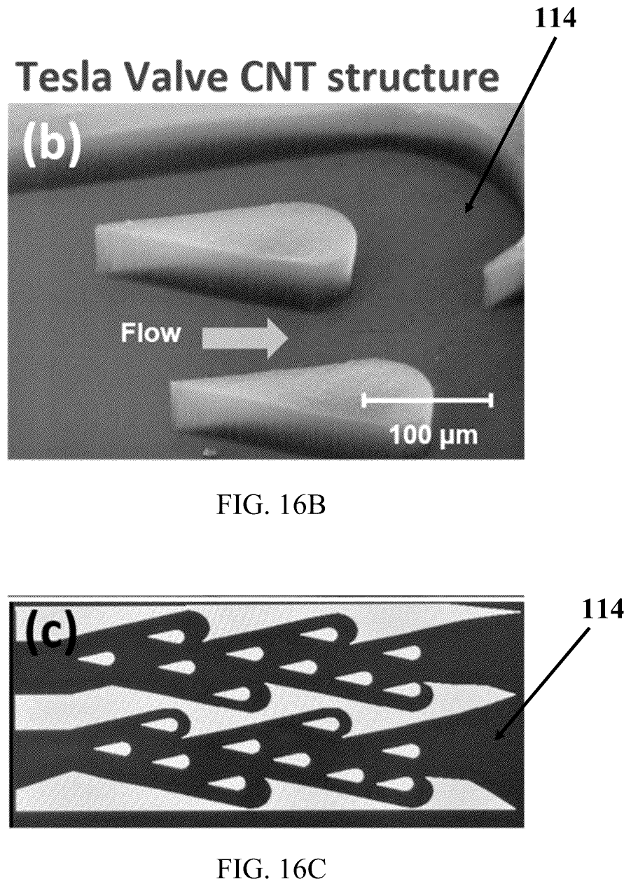

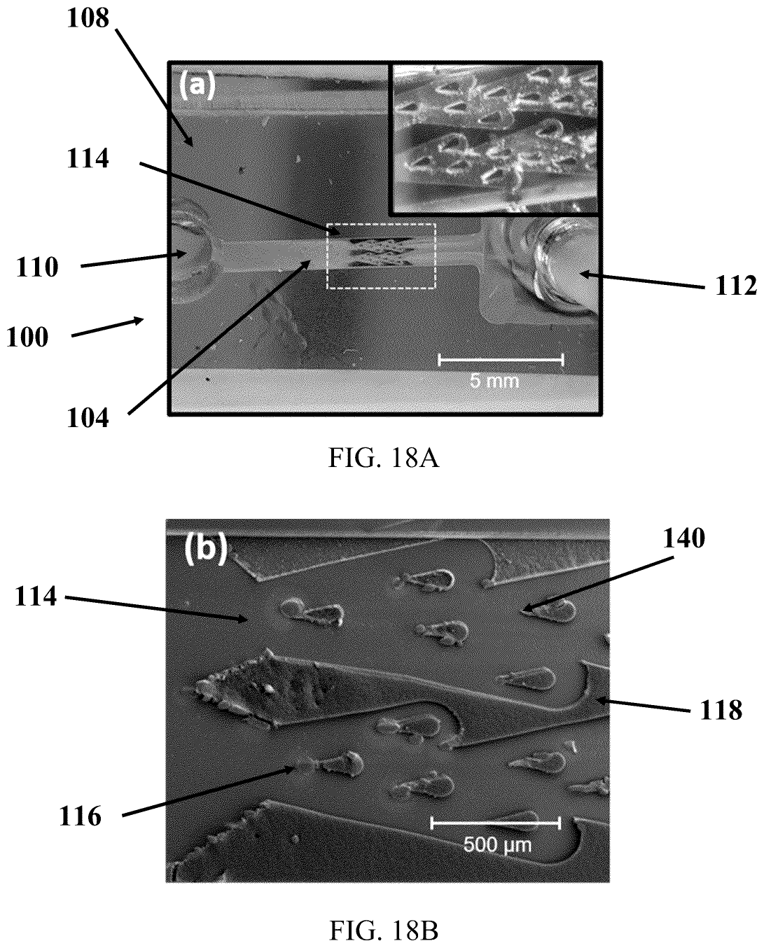

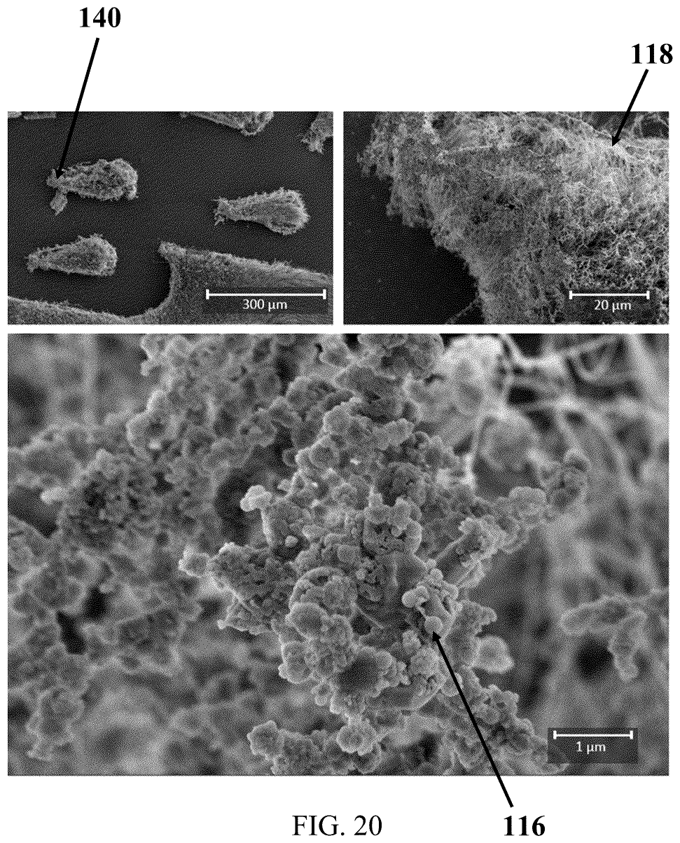

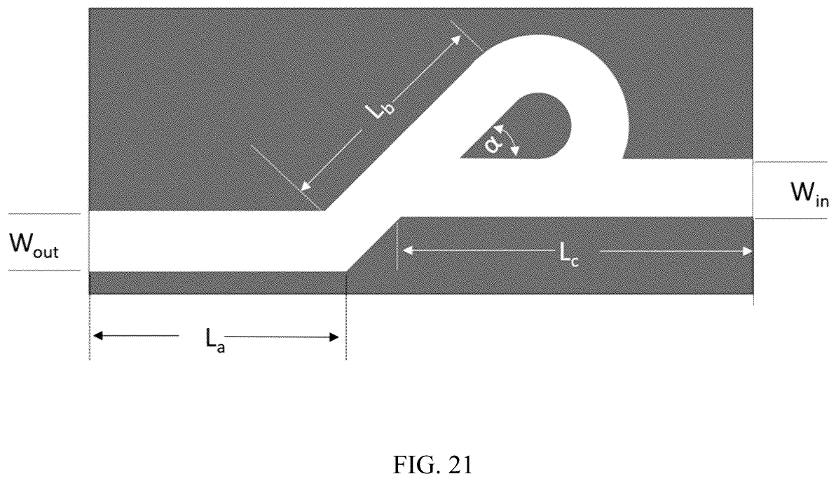

A Tesla valve 114 can be similar to conventional Tesla valves 114 found in the art. An exemplary unit cell of a Tesla valve 114 is shown in FIG. 21. The angle α and size of a fin within a Tesla valve 114 influences the forward and reverse flow directions. For example, depending on the angle, the cross section changes and can generate more turbulence at higher angle. As shown in FIG. 22, a Tesla valve 114 can allow the fluid to flow in one direction (e.g., forward flow direction) while simultaneously opposing the flow in the opposite direction (e.g., reverse flow direction). As shown in FIGS. 1 and 18A, a Tesla valve 114 can be positioned within a channel 104 such that the reverse flow direction is oriented from the inlet 110 to the outlet 112. In such embodiments, as shown in FIG. 16B, the means for pumping a fluid 124 overpowers the innate forward flow direction and directs the fluid through the Tesla valve 114 in the reverse flow direction. Alternatively, a Tesla valve 114 can be positioned within a channel 104 such that the forward flow direction is oriented from the inlet 110 to the outlet 112. It contemplated that the orientation of a Tesla valve 114 within a channel 104 can influence the degree of particle 116 retention (e.g., enrichment). As shown in FIGS. 6, 18B and 20, a device 100 where the reverse flow direction is oriented from the inlet 110 to the outlet 112, particle 116 enrichment increases, particularly at fin tips 140 and sharp corners of a Tesla valve 114. A Tesla valve 114 can be positioned within a channel 104 to allow at least a portion of a fluid to flow through the Tesla valve 114 in one direction from the inlet 110 to the outlet 112. As shown in FIG. 4, a Tesla valve 114 can be positioned within a channel 104 such that at least a portion of the fluid entering the device 100 passes through and around the Tesla valve 114 to exit the device 100. In some embodiments, the entire fluid entering the device 100 passes through the Tesla valve 114 to exit the device 100. A Tesla valve 114 can work under a low flow rate of fluid (e.g., 0.16-0.3 L/m).

A fluid monitoring device 100 can have a plurality of Tesla valves 114. In some embodiments, each channel 104 can have at least one Tesla valve 114. As shown in FIG. 18A, a single channel 104 can have a plurality of Tesla valves 114. A plurality of Tesla valves 114 can be positioned lengthwise along one channel 104. Alternatively, as shown in FIG. 18A, a plurality of Tesla valves 114 can positioned adjacent and crosswise within one channel 104. As shown in FIG. 1, a Tesla valve 114 can have any length L₂. The length L₂ can be on the order of micrometers to meters. The length L₂ of a Tesla valve 114 can be at least a portion of the length L₁ of a channel 104. In some embodiments, the length L₂ of a Tesla valve 114 is the same as the length L₁ of a channel 104. The shape of a Tesla valve 114 can complement the path shape of a channel 104 (e.g., straight, zig-zag, or serpentine, etc.). A Tesla valve 114 can be removable.

As shown in FIGS. 3 and 4, a Tesla valve 114 can have any depth D₂ and/or outer width W₂. The depth D₂ and/or outer width W₂ can be on the order of micrometers to meters. In some embodiments, the depth D₂ and/or outer width W₂ of a Tesla valve 114 can be about constant. Alternatively, the depth D₂ and/or outer width W₂ of a Tesla valve 114 can vary. As shown in FIG. 3, the depth D₂ and/or outer width W₂ of a Tesla valve 114 can complement the depth D₁ and/or width W₁ of a channel 104 such that the Tesla valve 114 fits tightly within the channel 104. As shown in FIG. 3, a Tesla valve 114 can have any inner width W₃. The inner width W₃ can be on the order of micrometers to meters. In some embodiments, the inner width W₃ of a Tesla valve 114 can vary. It is contemplated that the inner width W₃ of a Tesla valve 114 can be adjusted based on the fluid passing through the Tesla valve 114. For example, the fluid can be air containing droplets and aerosols. Approximately, droplets are greater than 100 μm, and aerosols are less than 100 μm. A larger inner width W₃ can capture larger droplets from air and vice versa.

A Tesla valve 114 can be made from any material (e.g., nanotubes, aerogels, nanowires, sponges, foams, etc.). The material of the Tesla valve 114 can be composed of any substance (e.g., silica, carbon, carbon nanotubes, cellulose, gelatin, agar, pectin, resorcinol-formaldehyde, phenol-formaldehyde, polyacrylates, polystyrenes, polyurethanes, epoxies, metal oxides, etc.). The materials can be shaped into the Tesla valve 114 using established methods in the art, for example casting a particular substance into a mold. As shown in FIGS. 3-6, in some embodiments, at least a portion of a Tesla valve 114 can be porous 122. In some embodiments, at least a portion of a Tesla valve 114 can have a porosity of 1-99%. For example, at least a portion of a Tesla valve 114 can have a porosity of about 90%. It can be appreciated that the porosity can be adjusted to fit the diameter of a particle 116 being captured (e.g., larger percent porosity for larger particles 116). The diameter of the particles 116 can be on the order of nanometers to millimeters.

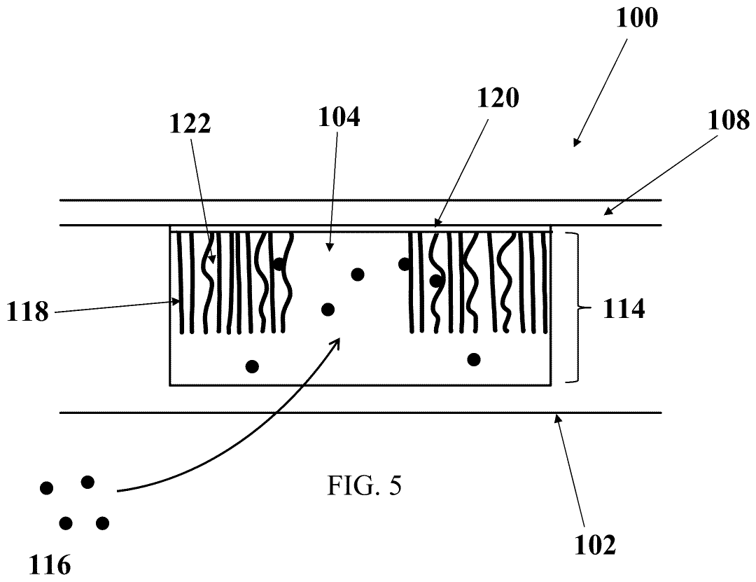

As shown in FIGS. 3, 6, and 18B, a Tesla valve 114 can be made from carbon nanotubes 118. A carbon nanotube-based Tesla valve 114 can be prepared using bottom-up synthesis. With the cover 108 removed, as shown in FIGS. 3 and 4, a substrate 120 is positioned within a channel 104 of the base 102. Alternatively, as shown in FIG. 5, the substrate 120 can be positioned on the underside of the cover 108 wherein the substrate 120 would align with at least a portion of a channel 104 when the fluid monitoring device 100 is assembled. A substrate 120 can be any type (e.g., silicon, glass, metals, polymers, etc.). A substrate can be foldable and flexible. Using e-beam evaporation and lift-off process, a metal catalyst can be prepared on a substrate 120. A metal catalyst can be any type (e.g., iron-, nickel-, cobalt-, etc.). Carbon nanotubes 118 can be grown vertically from a metal catalyst through aerosol-assisted chemical vapor deposition. As shown in FIG. 3-5, in some embodiments, at least a portion of the carbon nanotubes 118 are vertically aligned. To create the Tesla valve 114 shape, the metal catalyst can be patterned using lithography. Alternatively, laser etching of can be used to pattern the carbon nanotube 118 structure. In some embodiments, the carbon nanotube-based Tesla valve 114 is synthesized separately from the cover 108 or base 102 and configured to the channel 104 after synthesis. In addition, or in the alternative, the Tesla vale 114 can be formed via additive or subtractive shaping of carbon forest or sponges. It can be appreciated that other methods known in the art can be used to synthesize carbon nanotubes 118.

The length of time for aerosol-assisted chemical vapor deposition can vary and thus dictate the height of the carbon nanotubes 118. Increasing the time of aerosol-assisted chemical vapor deposition can generally increase the height of the carbon nanotubes 118 synthesized. It can be appreciated that the height of the carbon nanotubes 118 can dictate the depth D₂ of the Tesla valve 114. As shown in FIGS. 4 and 5, the height of the carbon nanotubes 118 can be at least a portion of the depth D₁ of the channel 104. Alternatively, as shown in FIG. 3, the height of the carbon nanotubes 118 can be approximately the same as or greater than the depth D₁ of the channel 104. In such embodiments, at least a portion of the ends of the carbon nanotubes 118 (e.g., ends opposite to that of the substrate 120) can make contact with the cover 108 or base 102. It is contemplated that contact of the base 102 or cover 108 with the ends of the carbon nanotubes 118 creates at least a partial seal such that at least a portion of a fluid flowing through a channel 104 is directed through the Tesla valve 114. It can be appreciated that some embodiments of the fluid monitoring device 100 may comprise a plurality of carbon nanotubes 118 types with varying heights.

The carbon nanotubes 118 can be single-walled or multi-walled. It can be appreciated that some embodiments of the fluid monitoring device 100 may comprise a plurality of carbon nanotube types being single-walled and multi-walled. The carbon nanotubes 118 can have any molecular structure (e.g., chirality) and include, but are not limited to, zigzag, armchair, and chiral. The carbon nanotubes 118 can also be chemically modified with atoms or molecules (e.g., doped). The chemical modifications can be any type and include, but are not limited to, the following: (1) endohedral doping; (2) exohedral doping or intercalation; and (3) inplane doping or substitution. For example, the carbon nanotubes 118 can be nitrogen-, boron-, silicon-, aluminum-, phosphorous-, and lithium-doped. Any suitable method known in the art can be used to dope the carbon nanotubes 118. It is contemplated that the doping type can be selected such that the captured particle 116 is preserved for future analysis. It can be appreciated that some embodiments of the fluid monitoring device 100 may comprise a plurality of carbon nanotubes 118 types with varying doping modifications and chirality.

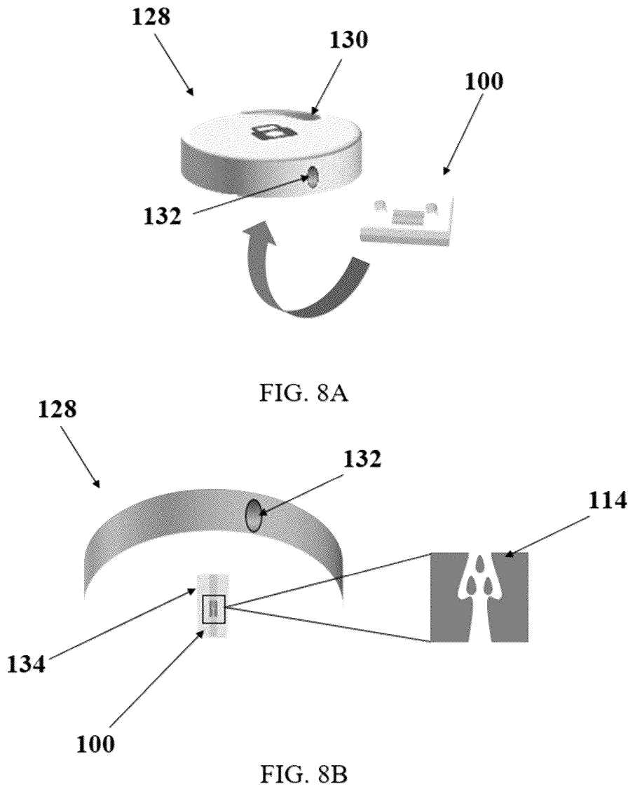

As shown in FIGS. 8A and 8B, the fluid monitoring device 100 can be configured to a housing 128. A housing 128 can have an inlet 130 and outlet 132. When a fluid monitoring device 100 is placed within a housing 128, the inlet 130 and outlet 132 of the housing 128 are adjacent to the inlet 110 an outlet 112 of the cover 108, respectively. It can be appreciated that when a fluid enters the device 100 through the inlet 130 of the housing 128, at least a portion of the fluid enters the inlet 110 of the cover 108 and into a channel 104. Similarly, when the fluid exits the outlet 112 of the cover 108, at least a portion of the fluid exits the outlet 132 of the housing 128. A housing 128 can have any number of inlets 130 and outlets 132. The number of inlets 130 and outlets 132 of a housing 128 can correspond to the number of inlets 110 and outlets 112 of a cover 108.

A housing 128 can be made of any material (e.g., plastics, metals, glass, polymers, polydimethylsiloxane (PDMS), etc.). As shown in FIG. 2, in some embodiments, a filter 126 can be positioned adjacent to the inlet 110 of a housing 128 and/or the inlet 110 of a cover 108 such that at least a portion of a fluid can pass through the filter(s) 126 to enter the channel 104. The porosity of the filter(s) 126 can be adjusted for the diameter of the particle 116 to be captured within the filter(s) 126.

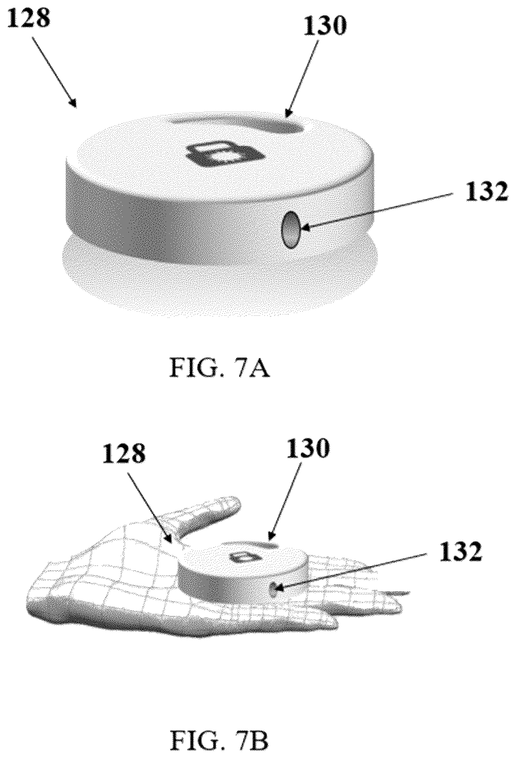

As shown in FIG. 8A, a fluid monitoring device 100 configured to a housing 128 can be removable and replaceable. As shown in FIG. 7B, it is contemplated that an assembled housing 128 and fluid monitoring device 100 can be light-weight and portable (e.g., <200 g). It is contemplated that a housing 128 can have an ergonomic shape to allow the housing 128 to fit comfortably within a user's hand or hands. A housing 128 can be wearable for ease of portability. For example, a housing 128 can be fastened to a shirt, bag, belt, pants, wrist, etc. using any suitable method (e.g., hook and loop fasteners, straps, buttons, magnets, adhesives, wrist bands, etc.).

An exemplary embodiment relates to a method of capturing particles 116 from a fluid sample using an embodiment of a fluid monitoring device 100. The embodiment of the fluid monitoring device 100 can comprise a base 102, cover 108, Tesla valve 114, and means for pumping a fluid 124. The base 102 can have a channel 104 wherein the channel 104 has two end points 106. The cover 108 can have an inlet 110 and an outlet 112. The cover 108 can be mounted on the base 102 wherein the inlet 110 is adjacent to the first end point 106 and the outlet 112 is adjacent to the second end point 106. The Tesla valve 114 can be positioned within the channel 104. The Tesla valve 114 can have a forward flow direction and a reverse flow direction. The means for pumping a fluid 124 is for directing a fluid from the inlet 110 to the outlet 112 and can be configured to the cover 108. The method can involve actuating the means for pumping a fluid 124. Actuating the means for pumping a fluid 124 can involve, but is not limited to, turning on a vacuum pump, pulling or pushing a syringe, or applying pressure to a squeeze bulb. For example, in some embodiments, the means for pumping a fluid 124 is a vacuum pump 124, the vacuum pump 124 being configured to the outlet 112 of the cover 108 and actuating the vacuum pump 124 pulls the fluid into the inlet 110 of the device 100, through the channel 104 and the Tesla valve 114, and out the outlet 112 of the device 100. The method can involve allowing the fluid to enter the inlet 110 of the device 100 and pass through a channel 104. It can be appreciated that the fluid can contain particles 116. The fluid can be a Newtonian (e.g., water, air, glycerol, etc.) or non-Newtonian fluid (e.g., blood, saliva, mucus, etc.). In some embodiments, the fluid is air containing droplets and aerosols carrying the particles 116. The particles 116 from the fluid can be any type (e.g., bacteria, virus, fungal spores, pollen, microalgae, plasmodium, amoebas etc.). The method can involve capturing the particles 116 within a Tesla valve 114. The capturing mechanism can involve the particles 116 becoming trapped within the porous material 122 of a Tesla valve 114. The method can involve allowing the fluid to exit the outlet 112 of the device 100. It can be appreciated that varying embodiments of the fluid monitoring device 100 can be implemented with the method. For example, the device 100 can also be configured to a portable housing 128.

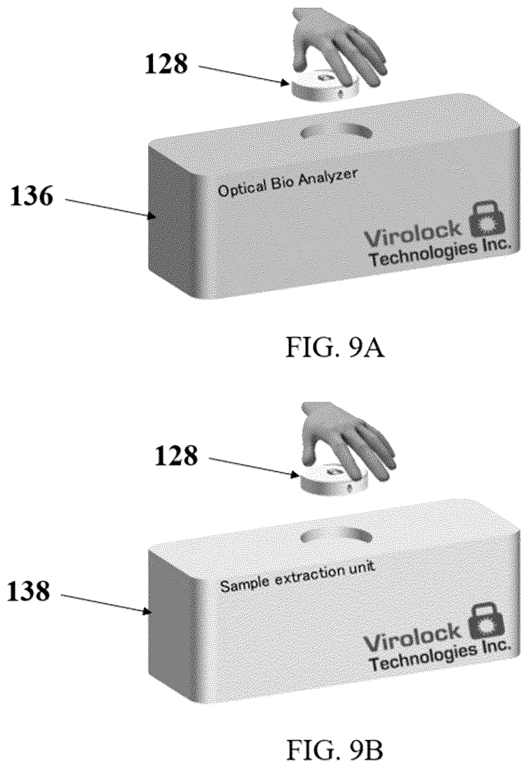

The method can also involve analyzing the captured particles 116. The fluid monitoring device 100 can work under a low flow rate of fluid. It is contemplated that the device 100 can capture a sufficient concentration of particles 116 required for analysis (e.g., particle enrichment). Analyzing the captured particles 116 can involve any optical technique known in the art (e.g., Raman spectroscopy, fluorescence spectroscopy, plasmonics, etc.). In some embodiments, the fluid monitoring device 100 can be configured to an optical analyzer 136 corresponding to the selected analysis technique for particle 116 assessment. As shown in FIG. 18A, in such embodiments, at least a portion of the base 102 and/or cover 108 is optically transparent so that at least a portion of a Tesla valve 114 within the device 100 is visible. As shown in FIG. 9A, a housing 128 containing the device 100 can also be configured to an optical analyzer 136. As shown in FIG. 8B, a housing 128 can have a transparent portion 134 or aperture 134 for optical analysis of the particles 116 captured by a device 100, the device 100 being contained within the housing 128.

The method can also involve releasing and analyzing the captured particles 116. With the cover 108 removed, the particles 116 can be released from the Tesla valve 114 via mechanical abrasion (e.g., cutting, scraping, scratching, etc.). Alternatively, the particles 116 can be released from the Tesla valve 114 via disruption of the particle 116 (e.g, lysis, etc.). In some embodiments, the fluid monitoring device 100 can be configured to a sample extraction unit 138 used to retrieve the particles 116 from the device 100. Alternatively, as shown in FIG. 9B, a housing 128 containing the device 100 can be configured to the sample extraction unit 138. A housing 128 can have an aperture 134 for extraction of the particles 116 captured by a device 100, the device 100 being contained within the housing 128. Analysis of the captured particles 116 can involve any technique known in the art (e.g., enzyme-linked immunosorbent assay (ELISA); polymerase chain reaction (PCR); next-generation sequencing (NGS), and culturing (e.g., inoculation of particles into embryonated egg or cell culture, etc.).

### Example: Air Sampling Devices Based on Carbon Nanotube (CNT) Arrays for Airborne Virus Monitoring

In this project, Virolock Technologies LLC developed and tested a bio-aerosol monitoring device. The devices included a large flow inertia-based collector where the impactor surface was enhanced by nanostructured carbon nanotube arrays. The best performance was achieved by using a micrometric carbon nanotube Tesla valve encapsulated in a microfluidic channel. This device requires low air flow and exhibited the highest particle/virus capture efficiency.

### Introduction

Virus detection in bio-aerosols has been attempted in the past under a variety of experimental conditions ranging from laboratory-controlled conditions to hospital wards, mass transportation and airplanes. Airborne virus detection has proven complicated. Table 1 shows the experimental conditions used to capture airborne viruses in different settings from well controlled laboratory conditions to ICU units with symptomatic patients. Table 1 was used in the statement of work of this project to display the efforts made towards aerosol virus capture, and for this report we have expanded it to include our experimental data.

TABLE 1
A survey of recently reported capture of airborne virus including SAR-CoV-2 in different
environmental settings, this updated table includes the result obtained in this project.
The last row represents our best performing device, i.e. the carbon nanotube tesla valve.

| | | | Collection | Sampled | | | |
|---|---|---|---|---|---|---|---|
| | Capture | | time | Volume | Flow | | |
| Virus | method | Product | (min) | (L) | (L/min) | Site | Result |
| MS2 virus | Laminar | VIVA | 5, 10, 15 | ≤105 | 7 | Lab | Positive |
| | flow on | | | | | | @1 × 10⁶ |
| | VTM | | | | | | |
| MS2 virus | Laminar | SKC bio- | 5, 10, 15 | ≤120 | 8 | Lab | Positive |
| | flow | sampler | | | | | @3 × 10⁷ |
| Adenovirus | Air- | SKC | | 630 | 3.5 | Mass transport | ~50% |
| | Sampler | Aircheck | | | | | positive |
| ADV, CoV | NIOSH | SKC | 60+ | ≥210 | 3.5 | Pig farms | Not |
| | BC-251 | Aircheck | | | | | Detected |
| PCV2 | NIOS | SKC | 60+ | ≥210 | 3.5 | Pig farms | 23% |
| | BC-251 | Aircheck | | | | | positive |
| Flu A, Flu B | NIOS | SKC | ~600 | ~2100 | 3.5 | Airplane | Not |
| H5N1 and | BC-251 | Aircheck | | | | transcontinental | Detected |
| more | | | | | | | |
| Flu A, Flu B | NIOS | SKC | 150 | 525 | 3.5 | Airplane | Not |
| H5N1 and | BC-251 | Aircheck | | | | transcontinental | Detected |
| more | | | | | | | |
| Adenovirus | NIOS | SKC | | 840 | 3.5 | Hospital | ~28% |
| | BC-251 | Aircheck | | | | | positive |
| Flu A | NIOS | SKC | | 840 | 3.5 | Hospital | ~3.5% |
| | BC-251 | Aircheck | | | | | positive |
| Flu B, Flu C. | NIOS | SKC | | 840 | 3.5 | Hospital | Not |
| CoV enterovirus | BC-251 | Aircheck | | | | | Detected |
| EV7 | Gelatin | SKC | 60 | 300 | 5 | Lab (BSL-2 | Cₜ~13 |
| | filter | Sioutas | | | | chamber) | @3 × 10⁵ |
| | | | | | | | TCID₅₀ |
| SARS-CoV-2 | Gelatin | SKC | 300-1200 | 1500-9000 | 5 | Hospital Wuhan | Not |
| | filter | Sioutas | | | | ICU | Detected |
| SARS-CoV-2 | Gelatin | SKC | 1200 | 10800 | 5-9 | Hospital Wuhan | 19 copies/m³ |
| | filter | Sioutas | | | | Toilet | |
| SARS-CoV-2 | Gelatin | SKC | 990 | ~8900 | 5-9 | Hospital Wuhan | 20 copies/m³ |
| | filter | Sioutas | | | | Offices | |
| IBV from | CNT | Battery | 30 | 4.8 | 0.16 | Chamber | Ct = 32.69 |
| vaccine | Tesla | operated | | | | | |
| | Valve | pump | | | | | |

In this project, we incorporated CNT arrays to the NIOSH cyclone sampler (BC-251, Tisch environmental Inc). The CNT arrays have demonstrated a high virus capture efficiency in liquid samples. The devices that we constructed and tested in this project were culture independent and we used polymerase chain reaction (PCR) analysis to determine the presence of the targeted pathogen (Chicken infectious Brochities Virus, IBV). PCR can indirectly quantify the concentration of the pathogen in aerosol samples; small threshold cycle (Ct) values indicate high amounts of virus genetic material within the sample. However, this number is not related to the ability of the sample or pathogen to propagate an infection.

### Method

### Aerosol Generation

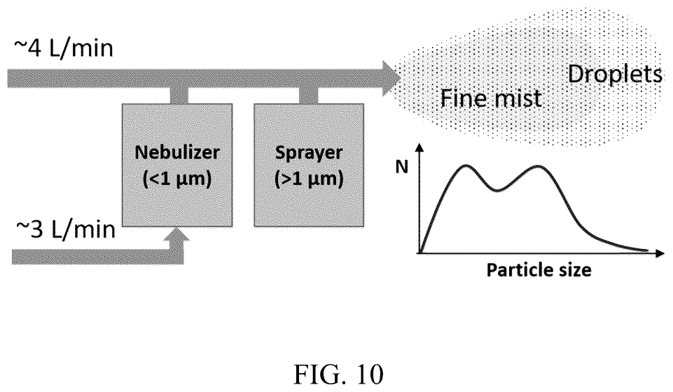

To generate a more realistic cough or sneeze aerosol particle distribution, we combined the particle emissions from mists and sprays generators. Bio-aerosols produced by cough or sneeze exhibit a bimodal particle distribution, large droplets (several μm) and smaller droplets (˜1 μm or less). In our system the fine mist will be generated by a high velocity air jet nebulizer for generating droplets less than 1 μm in diameter. Downstream, the larger droplets (droplets>1 μm) will be generated by a sprayer connected in series to produce a bimodal particle distribution (FIG. 10).

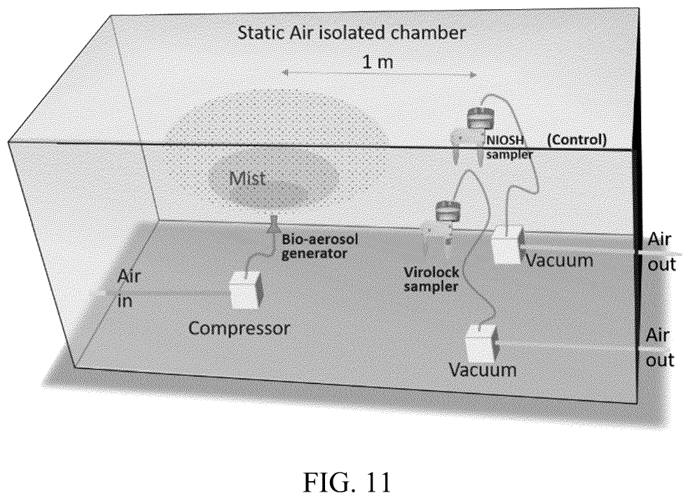

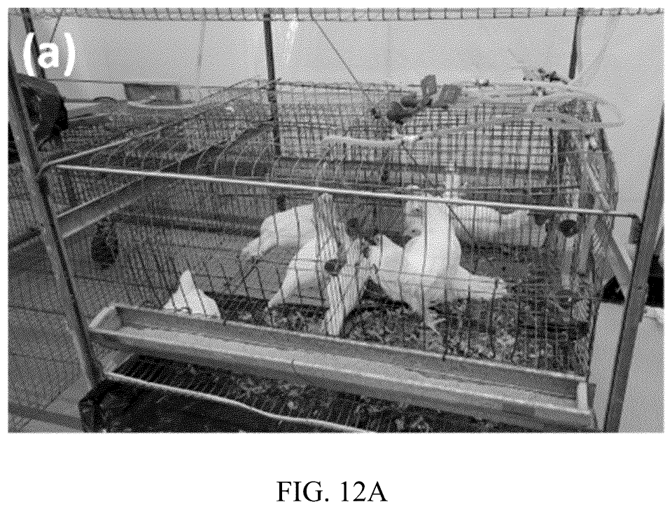

The nebulized and sprayed liquids were spiked with Infectious Bronchitis Virus (IBV) live virus vaccine at a concentration 20 Doses/ml. The virus-spiked bio-aerosol was released inside a clean air chamber ˜3 m³ (1.2×1.2×2 m) under static air conditions as depicted in (FIG. 11). The air monitoring collector devices were activated for different periods of time ranging from 30 to 660 minutes.

### Live Chicken Inside an Isolation Facility

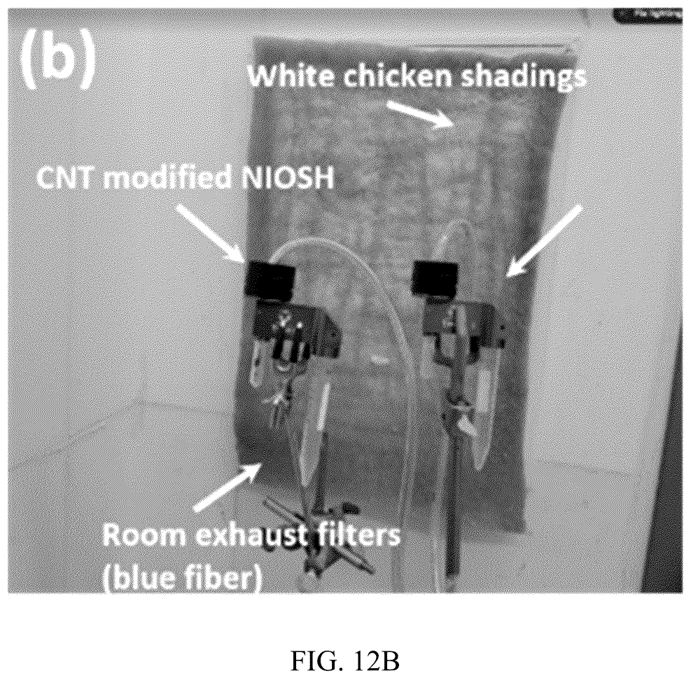

It was possible to perform an air monitoring experiment in a realistic situation where nine chickens were confined in a BSL-2 isolation room for a study of virus shedding by a veterinary research group at Penn State University. These chickens were inoculated for research purposes and our involvement was related to air monitoring. The isolation room has approximately 9 cubic meters and keeps a positive pressure and recirculating HEPA filtered air. The aerosol monitors were located ˜30 cm from the exhaust where accumulation of infected animal virus shedding can be easily observed in FIG. 12.

### Capture

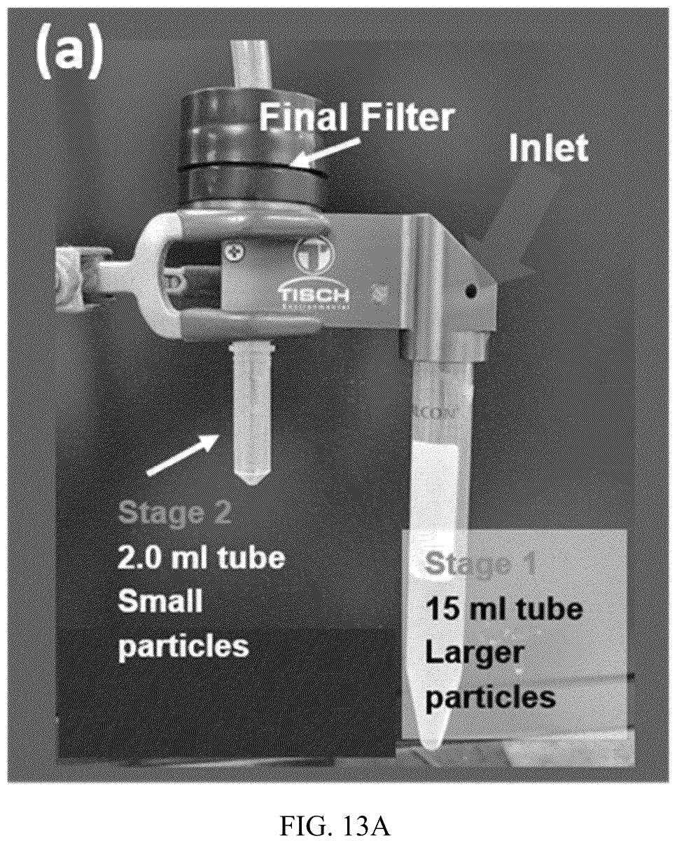

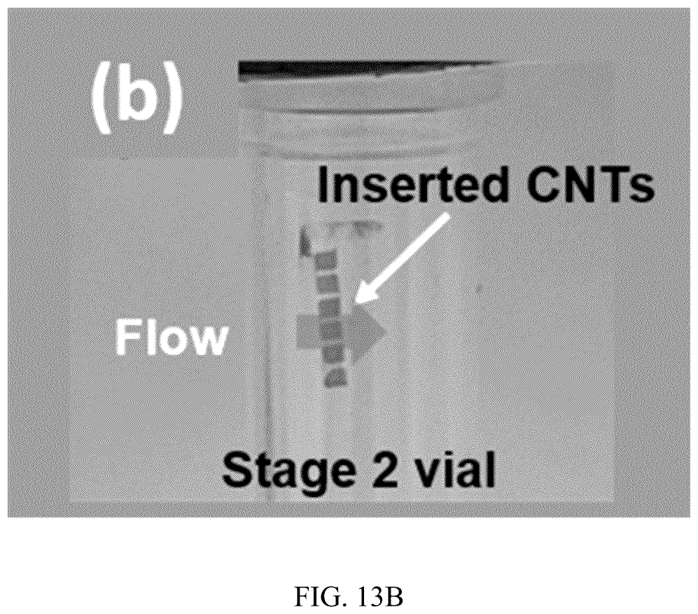

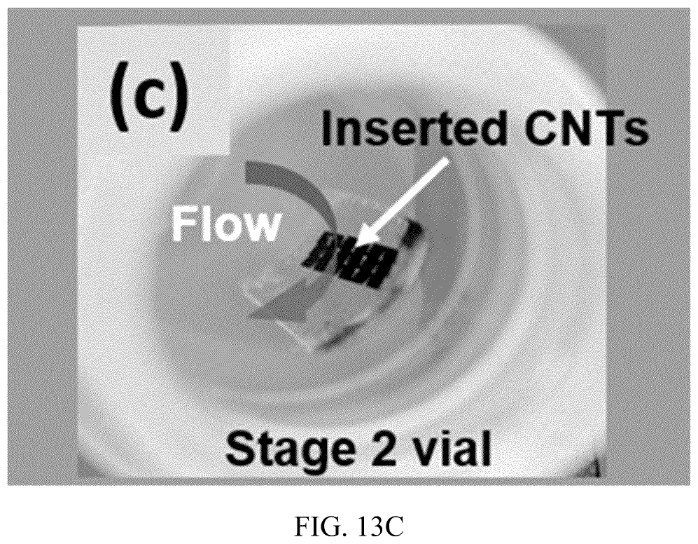

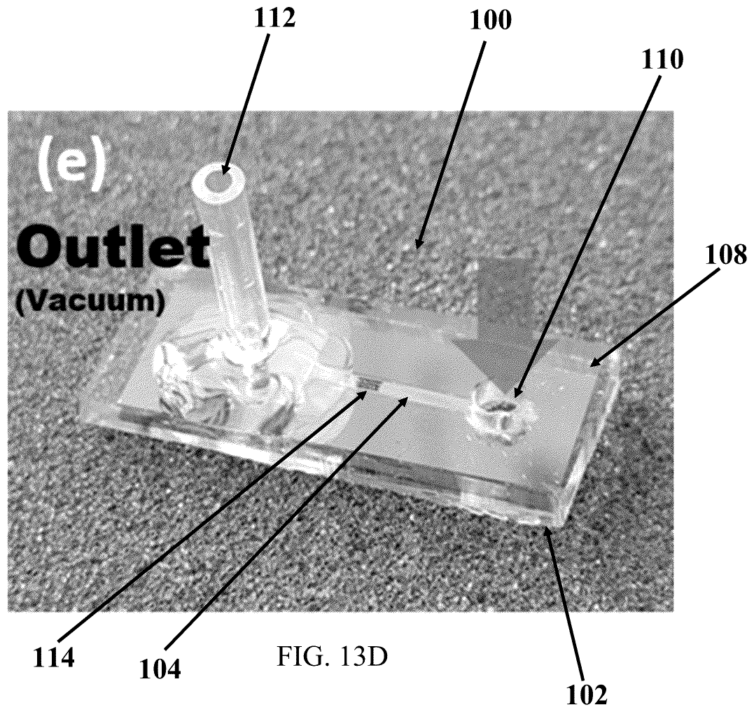

The bioaerosol samplers evaluated or developed in this project are: (1) NIOSH BC-251 cyclone sampler (Tisch environmental Inc), used as control or reference; (2) NIOSH BC-251 cyclone sampler with inserted CNT arrays (Hybrid device); (3) Dead-End CNT microfluidic filter; and (4) CNT Tesla Valve microfluidic filter. For clarity, FIG. 13A-D shows pictures of each of the tested devices.

TABLE 2
Operation conditions of each air sampler

| | Flow rate | Pressure differential | Capture Area |
|---|---|---|---|
| Air Sampler | (L/m) | (kPa) | (mm²) |
| NIOSH BC-251 | 5.0 | 50 | 9000 |
| NIOSH BC-251 + | 5.0 | 50 | 3 |
| CNT arrays | | | |
| CNT Tesla Valve | 0.16-0.3 | 7 | 3 |

### Evaluation

After the capturing experiments, we used scanning electron microscopy (SEM) and polymerase chain reaction (PCR) to identify and quantify the captured particles in the aerosol sampling devices.

Retrieval of Virions from Air Monitoring Devices

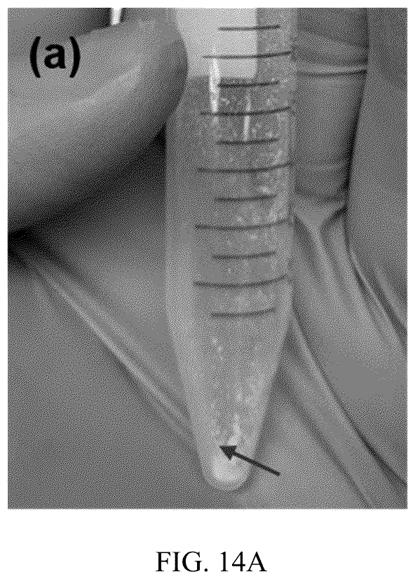

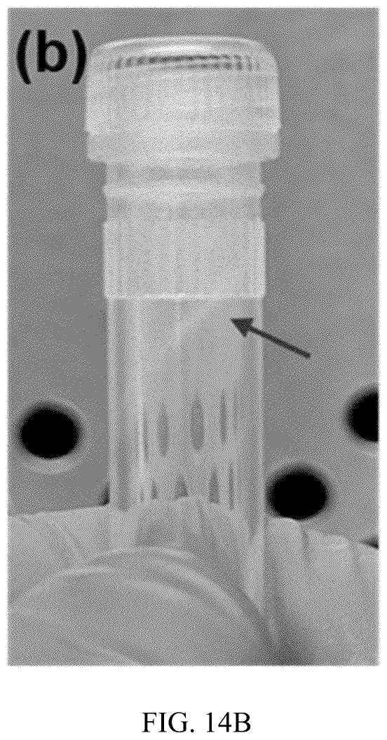

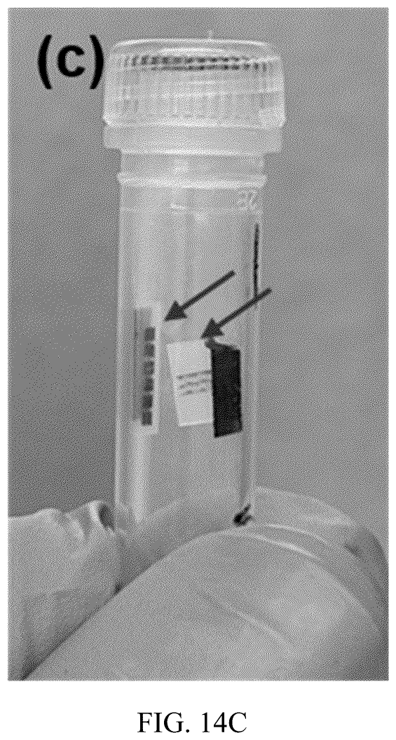

Genetic material retrieval from the commercial NIOSH particle traps. The air-sampling device uses conventional centrifuge vials, after the capture period, the device was transferred to a biosafety cabinet and disinfected on the exterior surface with 70% ethanol solution. The centrifugal tubes were filled with 300 μL of universal transport media (Copan UTM-RT 3 mL) and vortexed to suspend all the material attached to the inner vial surface. Subsequently, the vials were labelled and submitted for PCR analysis. FIGS. 14A and 14B show the vials used for air sampling displaying clear traces of the collected material (before rinsing with UTM).

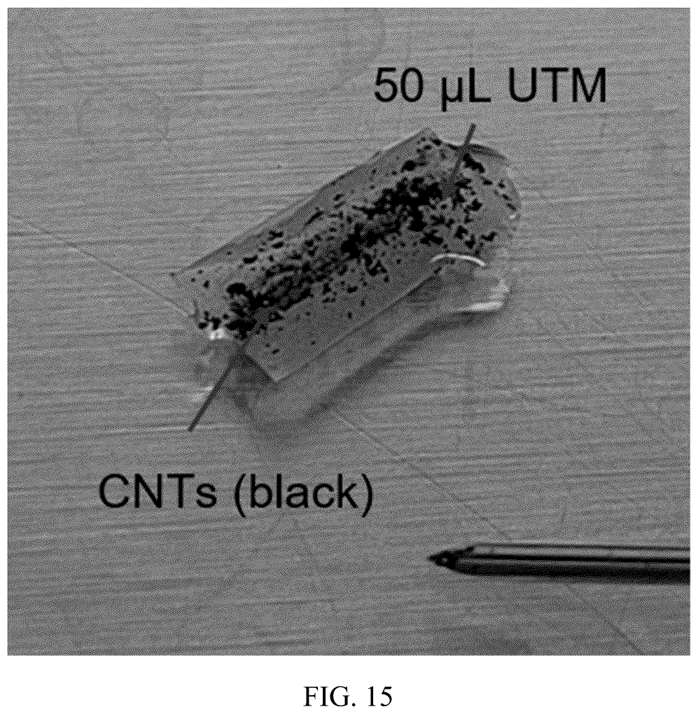

Genetic material retrieval from the CNT surface impactor. The CNT arrays were inserted in the vial using adhesives. To retrieve these CNTs we detached the CNT arrays and transferred to a sterile petri dish, there we poured 50 μL of UTM and scratched the CNTs to suspend them in the UTM droplet as depicted in FIG. 15. We collected the UTM+CNTs using a sterile pipette tip and diluted in 250 μL of UTM in a 1 mL vial and submit it for analysis by a standard PCR.

Genetic material retrieval from the CNT filter. Before attempting the lysis of the captured material, we tried the standard approach of opening the devices and scratching the CNTs and follow a conventional PCR analysis. The positive results obtained in the experiments reported here will enable us to develop and refine a protocol to perform in-situ lysation of the microfluidic air samplers to collect the genetic material without cutting (open) the microfluidic device. The reclaimed lysis liquid must fit with the protocols of the lab carrying out PCR analysis. This task has to be developed further at a future stage of this project.

### Scanning Electron Microscopy (SEM)

We performed SEM to observe and count the virions that were collected by the CNT devices. Similar to past studies, we quantified the virions captured by unit area from the virus-spiked nebulized/sprayed solutions.

### Polymerase Chain Reaction (PCR)

PCR was used to detect the presence IBV. We report the threshold cycle (Ct) value to deduce the capture efficiency of the device (when successfully detected).

### Results

During the development of this project we found that the geometry of the CNTs arrays must be carefully optimized for capturing airborne particles. During this process we found that one specific geometry exhibit advantages over plain forests of aligned CNT arrays. FIG. 15 shows the two CNT array geometries that were tested. First, we show in FIG. 16A the herringbone geometry that we have used in the past for liquids. When using this geometry we found that nanoparticles get trapped at the sharp corners of the CNT array. This effect diminish the overall capture ability of the array because those sharp tips that are not exposed can capture much less nanoparticles.

Aiming to find a novel geometry that maximizes the interaction of air with the CNTs, we hypothesized that a Tesla valve would be an ideal candidate. In short, a Tesla valve is a check valve which allows a fluid to flow in one direction (forward) while it opposes larger resistance to the flow in the opposite direction (reverse). This device has no moving parts, however the valve has limited applications because the flow in reverse direction is never zero. The ratio between the forward and reverse flows is called diodicity, it strongly depends on the flow speed and normal values are slightly larger than 1.

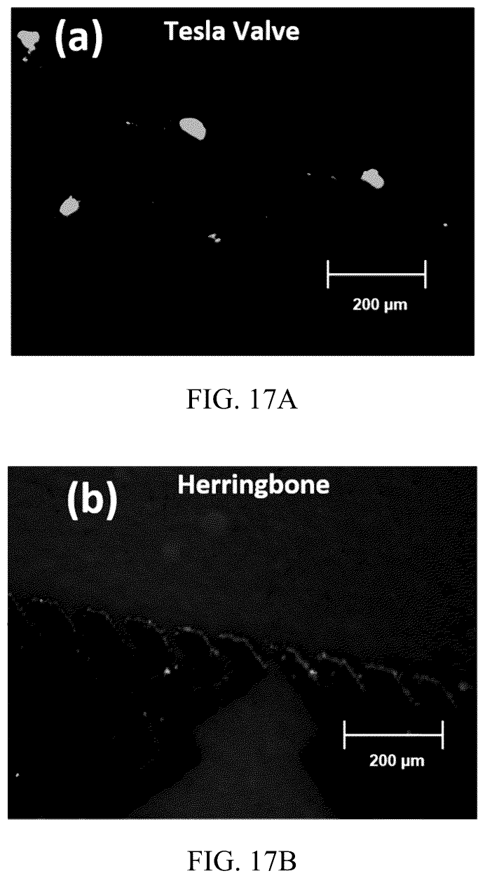

The diodicity of a Tesla valve originates from the different paths the fluid follows in forward and reverse directions. In the forward direction the fluid follows a smooth and shorter path while for the reverse direction it follows a longer path where it splits by the fins shown in FIGS. 16A and 16C. After being split the fluid direction is reversed by the cavity creating eddy flow regions in well-localized places of the valve. A comparison and control experiment where we nebulized fluorescent styrene nanoparticles demonstrated the superior capture ability of the CNT Tesla Valve when compared to the herringbone array (see FIG. 17).

Microfluidic carbon nanotube Tesla valves (CNT-TV) were used for capturing virus spiked aerosol in both static air and in the isolation chamber; experiments 7, 8 and 10 in Table 3. CNT-TV capture devices showed excellent performance, PCR analysis of these devices resulted in positive capture experiments performed in static air and a suspicious positive when capturing from real conditions in the isolation chamber containing infected chicken (with IBV) and active air filtration running continuously in the room. FIG. 18 shows the images of the CNT-TV after one capture experiment that lasted 30 min (Experiment 8, Table 3). After capture, there is optical evidence of trapped aerosol particles in the device (FIG. 18A). Further analysis by SEM reveals the presence of material captured in the CNTs, as depicted in false colored red shown in FIG. 18B. Furthermore, PCR analysis of the sample exposed under identical conditions confirmed the presence of IBV with a Ct value of 32.69. It is important to notice that these positive results were obtained when sampling 4.8 liters of air, which is two orders of magnitude smaller than the one sampled by the commercial air samplers (e.g., the National Institute for Occupational Safety and Health Bioaerosol Cyclone 251 (NIOSH BC-251)).

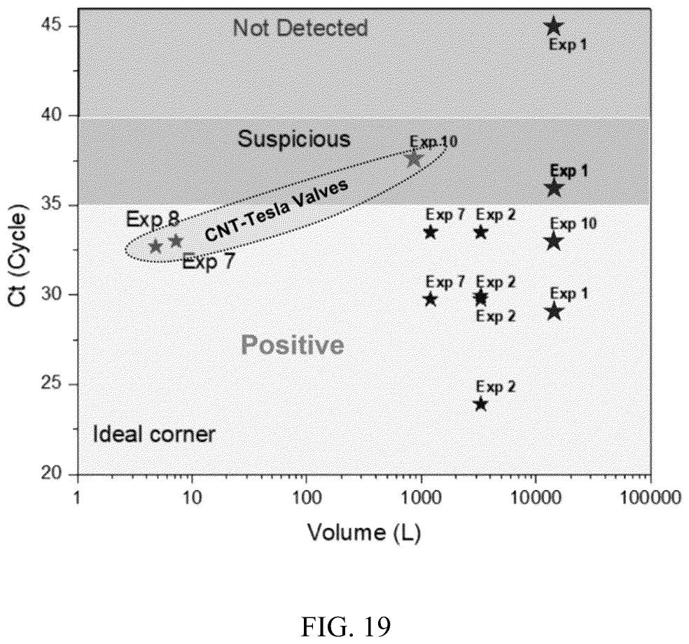

Table 3 shows the results of our capture experiments results. FIG. 19 displays the figure of merit of the NIOSH air sampler when compared to our carbon nanotube devices considering the sampled air volume vs. PCR threshold cycle of IBV detection. From the plot shown in FIG. 18 we can observe that the CNT Tesla valves are closer to the ideal corner where low Ct values and small air volumes are required. It is also important to notice that the CNT Tesla valve microfluidic achieved a comparable Ct value to the NIOSH sampler while sampling one order of magnitude less air. This result is truly outstanding.

TABLE 3
The experimental conditions and PCR result obtained in this project. The
last row represents our best performing device, i.e., the CNT tesla valve

| | | | | Collection | Sampled | | | Result | |
|---|---|---|---|---|---|---|---|---|---|
| | Capture | Pumping | | time | Volume | Flow | | Ct | |
| Virus | method | system | Stage | (min) | (L) | (L/min) | Site | value | Experiment |
| BBV | NIOSH | Virolock's | 2 | 2880 | 14400 | 5 | Isolation | 35.97 | Exp 1 |
| from | BC-251 | setup | | | | | room | | |
| chicken | | | | | | | | | |
| IBV | NIOSH | Virolock's | 2 | 2880 | 14400 | 5 | Isolation | 35.91 | Exp 1 |
| from | BC-251 | setup | | | | | room | | |
| chicken | | | | | | | | | |
| IBV | NIOSH | Virolock's | 1 | 2880 | 14400 | 5 | Isolation | 29.08 | Exp 1 |
| from | BC-251 | setup | | | | | room | | |
| chicken | | | | | | | | | |
| IBV | NIOSH | Virolock's | 1 | 2880 | 14400 | 5 | Isolation | 32.97 | Exp 10 |
| from | BC-251 | setup | | | | | room | | |
| chicken | | | | | | | | | |
| IBV | NIOSH | Virolock's | 2 | 2880 | 14400 | 5 | Isolation | Undetected | Exp 1 |
| from | BC-251 + | setup | | | | | room | | |
| chicken | CNTS | | | | | | | | |
| IBV | CNT | Virolock's | N/A | 2880 | 864 | 0.3 | Isolation | 37.57 | Exp 10 |
| from | Tesla | setup | | | | | room | | |
| chicken | Valve | | | | | | | | |
| IBV | NIOSH | Virolock's | 1 | 660 | 3300 | 5 | chamber | 29.96 | Exp 2 |
| from | BC-251 | setup | | | | | | | |
| vaccine | | | | | | | | | |
| IBV | NIOSH | Virolock's | 2 | 660 | 3300 | 5 | chamber | 23.9 | Exp 2 |
| from | BC-251 | setup | | | | | | | |
| vaccine | | | | | | | | | |
| IBV | NIOSH | Virolock's | 1 | 660 | 3300 | 5 | Chamber | 29.76 | Exp 2 |
| from | BC-251 + | setup | | | | | | | |
| vaccine | CNTS | | | | | | | | |
| IBV | NIOSH | Virolock's | 2 | 660 | 3300 | 5 | Chamber | 33.48 | Exp 2 |
| from | BC-251 + | setup | | | | | | | |
| vaccine | CNTS | | | | | | | | |
| IBV | NIOSH | Virolock's | 1 | 240 | 1200 | 5 | Chamber | 29.76 | Exp 7 |
| from | BC-251 + | setup | | | | | | | |
| vaccine | CNTS | | | | | | | | |
| IBV | NIOSH | Virolock's | 2 | 240 | 1200 | 5 | Chamber | 33.48 | Exp 7 |
| from | BC-251 + | setup | | | | | | | |
| vaccine | CNTS | | | | | | | | |
| IBV | CNT | Battery | N/A | 45 | 7.2 | 0.16 | chamber | 32.99 | Exp 7 |
| from | Tesla | operated | | | | | | | |
| vaccine | Valve | pump | | | | | | | |
| BBV | CNT | Battery | N/A | 30 | 4.8 | 0.16 | chamber | 32.69 | Exp 8 |
| from | Tesla | operated | | | | | | | |
| vaccine | Valve | pump | | | | | | | |

### Example: CNT Tesla Valve Test for Capturing SARS-COV-2 (BA.4.1 Strain)

### Experimental Procedure

1. Omicron BA.4.1 strain MEX-BC29-p2ve6/11.07.22 diluted to 1:100 and 1:1000 in a final volume of 1 mL. Both diluted samples were assessed by QRT-PCR before and after passing through the CNT Tesla Valves.
2. The samples were passed through the CNT Tesla Valve two times each.
3. After passing the diluted virus samples the PDMS polymer was removed to expose the CNT arrays. The CNTs were collected in 100 μL of PBS 1× to do RNA extraction using the Zymo™ kit.
4. The RNA extraction resulted in an eluted in 20 μL nucleotide free water.
5. QT PCR was done in a STEP-One System (Applied Biosystems) with the Zybio kit, The volume of the PCR reaction was 20 μL which included 10 μL of the virus sample.

### Results

TABLE 4
PCR results of the capture of SArS-CoV-2 in CNT Tesla Valves.

| Sample | C_{T} |
|---|---|
| Control de reaction (NTC) | Undetermined |
| virus stock non diluted | 9.07 |
| 1.100 input | 17.09 |
| 1.1000 input | 20.28 |
| 1.100 @ CNT Tesla | 28.17 |
| 1.1000 @CNT Tesla | 34.20 |
| Extraction Control (EC) | Undetermined |
| Positive control of the Kit | 27.92 |

From the PCR data after passing the diluted SARS-COV-2 samples it is possible to conclude that the CNT Tesla valve will not capture 100% of the virus in one pass. However, the captured virus is concentrated, as the volume where they are captured is extremely small (˜0.1 μL). An estimate of the copies/μL obtained from the CT values according to Brandolini et al, shows that the nanotube array captured of approximately 102 virus copies in a volume of 0.065 μL, resulting in a local enrichment, from literature it is possible to calculate the enrichment at the CNT of approximately 2×.

Subsequent experiments confirmed that virus capture can be increased by increasing the times the sample passes through the CNT tesla valve. For this experiment diluted virus samples were passed five and ten times through different Tesla valve devices. The results are shown in Table 5, where it is possible to notice that the sample recirculation through the CNT Tesla valve increases the virus retention. The sample recirculated 10 times is detected by PCR while the one recirculated 5 times shows no PCR amplification, these results were confirmed by triplicate experiments.

TABLE 5
PCR results of SArS-CoV-2 capture for samples
recirculated 5× and 10×.

| Sample | C_{T} |
|---|---|
| Control de reaction (NTC) | Undetermined |
| 1:1 × 10⁶ input | 32.01 |
| 5 times pass @ CNT Tesla | Undetermined |
| 10 times pass @ CNT Tesla | 39.58 |
| Extraction Control (EC) | Undetermined |
| Positive control of the Kit | 26.89 |

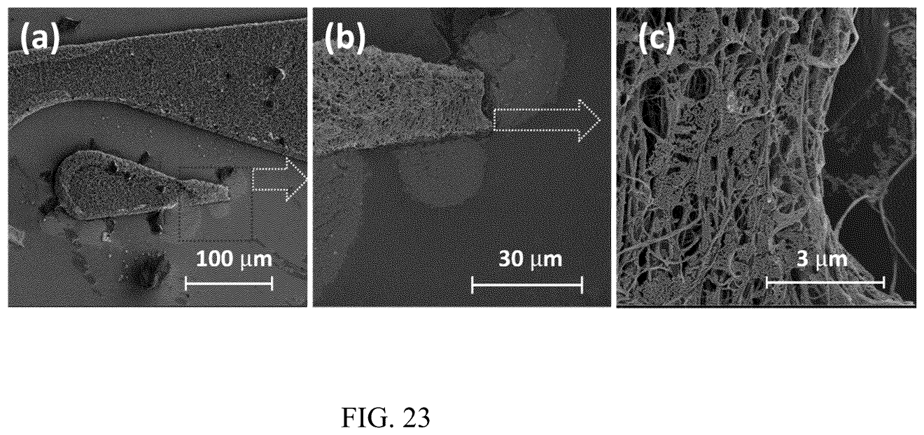

This was confirmed by scanning electron microscopy of SARS-COV-2 virus inactivated after capture in the CNT Tesla Valve. FIG. 23 shows the captured virus material in the nanotube arrays showing the preferential capture location observed in the air capture experiments.

In summary, SARS-COV-2 can be captured in CNT tesla valves and confined in a small volume. PCR analysis of the CNTs revealed the presence of SARS-COV-2. Recirculating the sample improves the capture of virus in the CNT tesla valve device.

### CONCLUSIONS

We developed a novel and efficient air sampler capable of detecting viruses from aerosolized water solutions containing viable (or inactivated) viruses from infected specimens in a BSL-2 isolation room. The novel air sampler is based on a CNT Tesla valve array and can be operated at very low flow rates (e.g., 0.16 L/min), thus making possible to fabricate highly portable battery-operated air sampling systems. In control experiments, these devices showed reproducible detection with consistent Ct values across different capture experiments. These microfluidic CNT devices could be used as portable pathogen exposure meters in airplanes where crew members can carry them while doing regular tasks during the whole flight. This approach shows a clear path to improve aerosol virus collection and detection with variable indoor conditions.

Results using modified commercial air samplers (NIOSH+CNT) resulted in improved virus concentration and detection from the hybrid devices containing CNT arrays. However, the additional steps required for collecting the sample might not represent competitive advantage to the currently available air samplers. Finally, we found that the geometry of the miniature dead-end filters was not adequate to concentrate viruses (or particles) on the CNTs despite the 500% increase in CNT dimensions; such air sampling device geometry will be discarded in future studies.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

Additional information can be appreciated from the following reference, each of which are incorporated herein by reference in their entireties.
Blachere, F. M.; Lindsley, W. G.; Weber, A. M.; Beezhold, D. H.; Thewlis, R. E.; Mead, K. R.; Noti, J. D., Detection of an avian lineage influenza A(H7N2) virus in air and surface samples at a New York City feline quarantine facility. Influenza Other Resp 2018, 12 (5), 613-622.
Coleman, K. K.; Nguyen, T. T.; Yadana, S.; Hansen-Estruch, C.; Lindsley, W. G.; Gray, G. C., Bioaerosol Sampling for Respiratory Viruses in Singapore's Mass Rapid Transit Network. Sci Rep-Uk 2018, 8.
Borkenhagen, L. K.; Mallinson, K. A.; Tsao, R. W.; Ha, S. J.; Lim, W. H.; Toh, T. H.; Anderson, B. D.; Fieldhouse, J. K.; Philo, S. E.; Chong, K. S.; Lindsley, W. G.; Ramirez, A.; Lowe, J. F.; Coleman, K. K.; Gray, G. C., Surveillance for respiratory and diarrheal pathogens at the human-pig interface in Sarawak, Malaysia. Plos One 2018, 13 (7).
Blachere, F. M.; Lindsley, W. G.; Slaven, J. E.; Green, B. J.; Anderson, S. E.; Chen, B. T.; Beezhold, D. H., Bioaerosol sampling for the detection of aerosolized influenza virus. Influenza Other Resp 2007, 1 (3), 113-120.
Hertzberg, V. S.; Weiss, H.; Elon, L.; Si, W. P.; Norris, S. L.; Team, F. R., Behaviors, movements, and transmission of droplet-mediated respiratory diseases during transcontinental airline flights. P Natl Acad Sci USA 2018, 115 (14), 3623-3627.
Lindsley, W. G.; Green, B. J.; Blachere, F. M.; Martin, S. B.; Law, B. F.; Jensen, P. A.; Schefer, M. P., Sampling and characterization of bioaerosols. In NIOSH Manual of Analytical Methods, 5th ed.; NIOSH, Ed. NIOSH: 2017.
Pan, M.; Eiguren-Fernandez, A.; Hsieh, H.; Afshar-Mohajer, N.; Hering, S. V.; Lednicky, J.; Fan, Z. H.; Wu, C. Y., Efficient collection of viable virus aerosol through laminar-flow, water-based condensational particle growth. J Appl Microbiol 2016, 120 (3), 805-815.
Yadana, S.; Coleman, K. K.; Nguyen, T. T.; Hansen-Estruch, C.; Kalimuddin, S.; Thoon, K. C.; Low, J. G. H.; Gray, G. C., Monitoring for airborne respiratory viruses in a general pediatric ward in Singapore. J Public Health Res 2019, 8 (3), 100-103.
Liu, Y.; Ning, Z.; Chen, Y.; Guo, M.; Liu, Y. L.; Gali, N. K.; Sun, L.; Duan, Y. S.; Cai, J.; Westerdahl, D.; Liu, X. J.; Xu, K.; Ho, K. F.; Kan, H. D.; Fu, Q. Y.; Lan, K., Aerodynamic analysis of SARS-COV-2 in two Wuhan hospitals. Nature 2020, 582 (7813), 557-560.
Yeh, Y. T.; Tang, Y.; Sebastian, A.; Dasgupta, A.; Perea-Lopez, N.; Albert, I.; Lu, H. G.; Terrones, M.; Zheng, S. Y., Tunable and label-free virus enrichment for ultrasensitive virus detection using carbon nanotube arrays. Sci Adv 2016, 2 (10).
Martinez, J. F. I.; Perea-Lopez, N.; Rajotte, E.; Terrones, M.; Rosa, C., Ultrasensitive and in-situ detection of a plant virus by a nanotube-filtering device and isothermal amplification. Phytopathology 2019, 109 (10), 133-134.
Yeh, Y. T.; Gulino, K.; Zhanga, Y. H.; Sabestien, A.; Chou, T. W.; Zhou, B.; Lin, Z.; Albert, I.; Lu, H. G.; Swaminathan, V.; Ghedin, E.; Terrones, M., A rapid and label-free platform for virus capture and identification from clinical samples. P Natl Acad Sci USA 2020, 117 (2), 895-901.
Nguyen, T. T.; Poh, M. K.; Low, J.; Kalimuddin, S.; Thoon, K. C.; Ng, W. C.; Anderson, B. D.; Gray, G. C., Bioaerosol Sampling in Clinical Settings: A Promising, Noninvasive Approach for Detecting Respiratory Viruses. Open Forum Infect Di 2017, 4 (1).
Lindsley, W. G.; Reynolds, J. S.; Szalajda, J. V.; Noti, J. D.; Beezhold, D. H., A Cough Aerosol Simulator for the Study of Disease Transmission by Human Cough-Generated Aerosols. Aerosol Sci Tech 2013, 47 (8), 937-944.
Nazari, A.; Jafari, M.; Rezaei, N.; Taghizadeh-Hesary, F.; Taghizadeh-Hesary, F., Jet fans in the underground car parking areas and virus transmission. Phys Fluids 2021, 33 (1).
Mathai, V.; Das, A.; Bailey, J. A.; Breuer, K., Airflows inside passenger cars and implications for airborne disease transmission. Sci Adv 2021, 7 (1).
Verma, A. K.; Bhatnagar, A.; Mitra, D.; Pandit, R., First-passage-time problem for tracers in turbulent flows applied to virus spreading. Phys Rev Res 2020, 2 (3).
Cox, J.; Mbareche, H.; Lindsley, W. G.; Duchaine, C., Field sampling of indoor bioaerosols. Aerosol Sci Tech 2020, 54 (5), 572-584.

What is claimed is:

1. A fluid monitoring device comprising:
a base, the base having a channel wherein the channel has two end points;
a cover, the cover having an inlet and an outlet, the cover being mounted on the base wherein the inlet is adjacent to the first end point and the outlet is adjacent to the second end point;
a Tesla valve positioned within the channel, wherein the Tesla valve has a forward flow direction and a reverse flow direction; and
means for pumping a fluid through the channel from the inlet to the outlet, the means for pumping being configured to the cover.

2. The fluid monitoring device of claim 1, wherein at least a portion of the fluid monitoring device is optically transparent whereby at least a portion of the Tesla valve is visible within the fluid monitoring device.

3. The fluid monitoring device of claim 1, wherein the fluid is air containing droplets and aerosols.

4. The fluid monitoring device of claim 1, wherein the Tesla valve is positioned within the channel such that the reverse flow direction is oriented from the inlet to the outlet.

5. The fluid monitoring device of claim 1, wherein the Tesla valve is positioned within the channel such that the forward flow direction is oriented from the inlet to the outlet.

6. The fluid monitoring device of claim 1, wherein the Tesla valve is positioned within the channel to allow at least a portion of the fluid to flow through and around the Tesla valve.

7. The fluid monitoring device of claim 1, wherein at least a portion of the Tesla valve is porous.

8. The fluid monitoring device of claim 1, wherein the length of the Tesla valve is at least a portion of the length of the channel.

9. The fluid monitoring device of claim 1, further comprising a second Tesla valve positioned within the channel.

10. The fluid monitoring device of claim 1, wherein the channel has a path shape, wherein the path shape is straight, zig-zag, or serpentine.

11. The fluid monitoring device of claim 1, wherein the means for pumping a fluid is a vacuum pump, the vacuum pump being configured to the outlet of the cover.

12. The fluid monitoring device of claim 1, wherein the device is contained in a portable housing.

13. A method of capturing particles from a fluid sample using a fluid monitoring device, the fluid monitoring device comprising: a base, the base having a channel wherein the channel has two end points; a cover, the cover having an inlet and an outlet, the cover being mounted on the base wherein the inlet is adjacent to the first end point and the outlet is adjacent to the second end point; a Tesla valve positioned within the channel, wherein the Tesla valve has a forward flow direction and a reverse flow direction; and means for pumping a fluid through the channel from the inlet to the outlet, the means for pumping configured to the cover; the method comprising:
actuating the means for pumping a fluid;
allowing a fluid to enter the inlet of the device and pass through the channel, the fluid containing particles;
capturing the particles within the Tesla valve; and
allowing the fluid to exit the outlet of the device.

14. The method of claim 13, wherein the fluid is air containing droplets and aerosols carrying the particles.

15. The method of claim 14, wherein the particles are selected from the group consisting of bacteria, virus, fungal spores, pollen, microalgae, plasmodium, and amoebas.

16. The method of claim 13, wherein the means for pumping a fluid is a vacuum pump, the vacuum pump being configured to the outlet of the cover and actuating the vacuum pump pulls the fluid into the inlet of the device, through the channel and the Tesla valve, and out the outlet of the device.

17. The method of claim 13, further comprising analyzing the captured particles.

18. The method of claim 17, wherein analyzing the captured particles comprises a technique selected from the group consisting of Raman spectroscopy, fluorescence spectroscopy, and plasmonics.

19. The method of claim 13, further comprising releasing the captured particles and analyzing the captured particles.

20. The method of claim 19, wherein releasing the captured particles comprises mechanical abrasion of the Tesla valve and analyzing the particles comprises a technique selected from the group consisting of ELISA, PCR, NGS, and culture.

21. The method of claim 13, further comprising recirculating the fluid before to exiting the outlet of the device to increase a number of particles captures within the Tesla valve or a likelihood of capturing the particles within the Tesla valve.
